(19) United States
(12) Patent Application Publication
(10) Pub. No.: US 2025/0087779 A1
(43) Pub. Date: Mar. 13, 2025

(54) TAMPER RESISTANT WATER ACCESS PORT FOR RECHARGABLE ENERGY STORAGE SYSTEM OF A VEHICLE

(71) Applicant: GM Global Technology Operations LLC, Detroit, MI (US)

(72) Inventors: Ryan Patrick Hickey, Austin, TX (US); Michael G. Leffert, Howell, MI (US)

(21) Appl. No.: 18/462,766

(22) Filed: Sep. 7, 2023

(51) Int. Cl. H01M 10/613; A62C 3/16; A62C 37/11; B60L 50/64; H01M 10/625; H01M 10/6568; H01M 50/204; H01M 50/249; H01M 50/262

(52) U.S. Cl. CPC H01M 10/613; A62C 3/16; A62C 37/11; B60L 50/64; H01M 10/625; H01M 10/6568; H01M 50/204; H01M 50/249; H01M 50/262; H01M 2200/10; H01M 2200/20; H01M 2220/20

(57) ABSTRACT

A battery assembly of a vehicle includes a one or more battery cells, a battery housing in which the one or more battery cells are positioned, and a suppressant conduit extending from the battery housing and configured to deliver a flow of fire suppressant to the one or more battery cells. An activation element is configured to block the suppressant conduit and activate when a pressure exceeding a preselected threshold pressure is applied to the activation element, allowing a flow of fire suppressant to flow into the battery housing.

### INTRODUCTION

The subject disclosure relates to vehicles, and vehicles having high-capacity battery assemblies.

High capacity battery assemblies are utilized in many consumer and industrial sectors categorically including transportation and power grid applications. High capacity battery packs are known to include a plurality of battery assembly modules allowing for flexibility in configurations and adaptation to application requirements. Such battery assemblies generate heat and internal pressure when placed under load. Heat may have a detrimental effect on battery efficiency and/or battery life, and a buildup of internal temperature and pressure may lead to failure of the battery assembly.

In the occurrence of a thermal event greater than design conditions, it is desired to direct fire suppressant such as water to the battery assembly. Since the battery assembly is typically embedded inside the vehicle structure, however, it is difficult to direct the water to act directly on the battery assembly. One solution is to provide a conduit open to the vehicle exterior through which the water can be flowed directly to the battery assembly. Such conduits, however, may be subject to tampering, such that fluids or other foreign objects may be passed through the conduit into the battery assembly.

### SUMMARY

In one exemplary embodiment, a battery assembly of a vehicle includes a one or more battery cells, a battery housing in which the one or more battery cells are positioned, and a suppressant conduit extending from the battery housing and configured to deliver a flow of fire suppressant to the one or more battery cells. An activation element is configured to block the suppressant conduit and activate when a pressure exceeding a preselected threshold pressure is applied to the activation element, thus allowing a flow of fire suppressant to flow into the battery housing.

In addition to one or more of the features described herein, a conduit fitting is secured to the battery housing and the suppressant conduit is operably connected thereto. The activation element is positioned inside the conduit fitting.

In addition to one or more of the features described herein the activation element is secured in the conduit fitting by one of welding, brazing, crimping or sealing.

In addition to one or more of the features described herein, the activation element is configured to activate at a pressure of 50 psi or greater.

In addition to one or more of the features described herein, the pressure disk is configured to activate at a temperature greater that 1200 degrees Celsius.

In addition to one or more of the features described herein, the activation element includes one or more localized reductions in thickness to enable the activation at the preselected threshold pressure.

In addition to one or more of the features described herein, the activation element is formed from a metallic material.

In addition to one or more of the features described herein, the suppressant conduit extends from the battery housing to a flood port located at an exterior of the vehicle.

In another exemplary embodiment, a vehicle includes a vehicle body defining a passenger compartment, and a battery assembly located at the vehicle body. The battery assembly includes a one or more battery cells, a battery housing in which the one or more battery cells are positioned, and a suppressant conduit extending from the battery housing and configured to deliver a flow of fire suppressant to the one or more battery cells. An activation element is configured to block the suppressant conduit and to activate when a pressure exceeding a preselected threshold pressure is applied to the activation element, allowing the flow of fire suppressant to flow into the battery housing.

In addition to one or more of the features described herein, a conduit fitting is secured to the battery housing and the suppressant conduit is operably connected thereto. The activation element is positioned inside the conduit fitting.

In addition to one or more of the features described herein, the activation element is secured in the conduit fitting by one of welding, brazing, crimping or sealing.

In addition to one or more of the features described herein, the activation element is configured to activate at a pressure of 50 psi or greater.

In addition to one or more of the features described herein, the activation element is configured to activate at a temperature greater that 1200 degrees Celsius.

In addition to one or more of the features described herein, the activation element includes one or more localized reductions in thickness to enable the activation at the preselected threshold pressure.

In addition to one or more of the features described herein, the activation element is formed from a metallic material.

In addition to one or more of the features described herein, the suppressant conduit extends from the battery housing to a flood port positioned at an exterior of the vehicle body.

In yet another exemplary embodiment, a method includes positioning an activation element between a suppressant conduit and a battery assembly of a vehicle, directing a flow of suppressant along the suppressant conduit toward the battery assembly, activating the activation element via the suppressant pressure on the activation element, and flowing the suppressant into the battery assembly.

In addition to one or more of the features described herein, the activation element is configured to activate at a pressure of 50 psi or greater.

In addition to one or more of the features described herein, a conduit fitting is secured to the battery assembly and the suppressant conduit is operably connected thereto. The activation element is positioned inside the conduit fitting, and the activation element is secured in the conduit fitting by one of welding, brazing, crimping or sealing.

In addition to one or more of the features described herein, the flow of suppressant is directed along the suppressant conduit via a flood opening at an exterior of the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic illustration of an embodiment of a vehicle;

FIG. 2 is a schematic illustration of an embodiment of a battery assembly;

FIG. 3 is a schematic illustration of an embodiment of a suppressant conduit connection to a housing of a battery assembly;

FIG. 4 is a schematic illustration of another embodiment of a suppressant conduit connection to a housing of a battery assembly;

FIG. 5 is a perspective view of an embodiment of a pressure disk; and

FIG. 6 is a schematic illustration of a method of assembly of a battery assembly.

### DETAILED DESCRIPTION

The following description is merely exemplary in nature and is not intended to limit the present disclosure, its application or uses. It should be understood that throughout the drawings, corresponding reference numerals indicate like or corresponding parts and features.

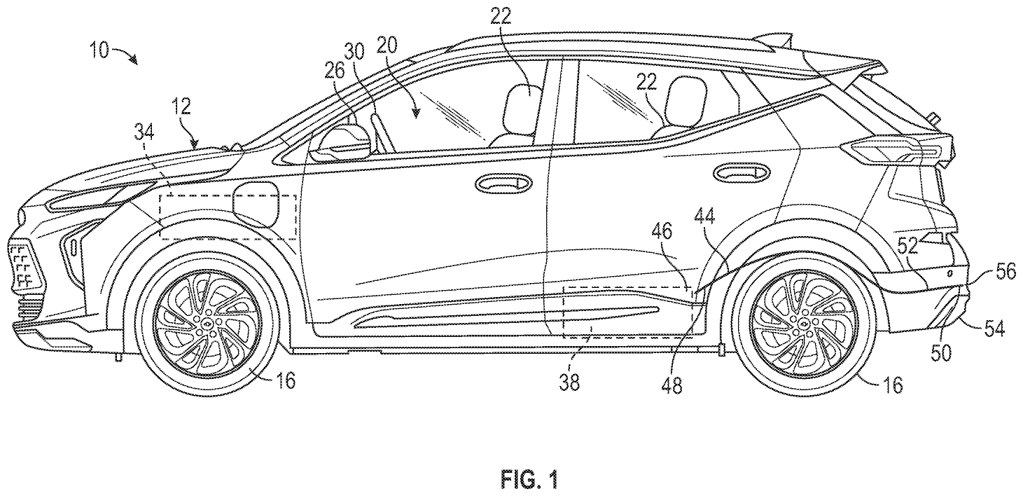

In accordance with an exemplary embodiment a vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. Body 12 defines, in part, a passenger compartment 20 having seats 22 positioned behind a dashboard 26. A steering control 30 is arranged between seats 22 and dashboard 26. Steering control 30 is operated to control orientation of the steerable wheel(s). Vehicle 10 includes an electric motor 34 connected to a transmission that provides power to one or more of the plurality of wheels 16. A rechargeable energy storage system (RESS) or battery assembly 38 provides power to electric motor 34.

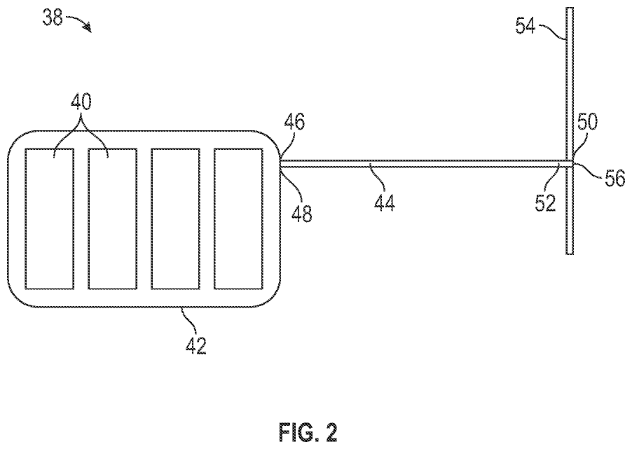

Referring to now FIG. 2, the battery assembly 38 includes a plurality of battery cells 40 disposed in a battery housing 42. A suppressant conduit 44 is fluidly connected to the battery assembly 38 at a conduit port 46 in the battery housing 42. In some embodiments, the suppressant conduit 44 is a tubular element formed from, for example, a plastic or rubber material. Referring again to FIG. 1, the suppressant conduit 44 extends from the battery assembly 38 at a first conduit end 48 to an exterior location on the body 12, terminating at a flood port 50 in the exterior location on the body 12 at a second conduit end 52. In some embodiments, the flood port 50 is at a rear portion of the body 12 at, for example, a rear bumper cover 54 of the body 12. In some embodiments, a movable or removable port cover 56 is installed over the flood port 50.

Referring again to FIG. 2, the suppressant conduit 44 provides access to the battery assembly 38 from outside of the vehicle 10 for the injection of fire suppressant, such as water or the like, directly into the battery assembly 38 in the event of a thermal runaway event greater than design conditions. An open conduit from the exterior location on the body 12 to the battery assembly 38, however, may subject the suppressant conduit 44 and thus the battery assembly 38 to tampering, and may also prevent sealing of the battery assembly 38 in the battery housing 42.

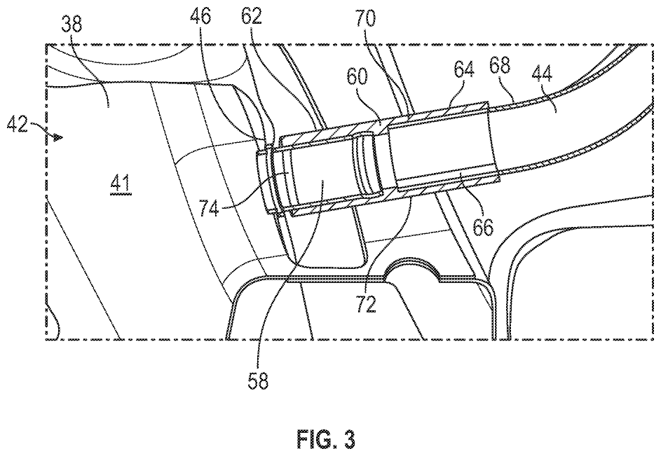

Referring now to FIG. 3, illustrated in the connection of the suppressant conduit 44 to the battery housing 42 at the conduit port 46. This connection is achieved via a conduit fitting 58. The conduit fitting 58 is, in some embodiments, a flared nipple secured to the battery housing 42 at the conduit port 46 by, for example, welding, brazing, crimping or the like. A conduit sleeve 60 is installed over the conduit fitting 58 and is in some embodiments, a tubular element having a first sleeve portion 62 secured to the conduit fitting 58. In some embodiments, a sealant is utilized to seal the connection of the first fitting portion 62 to the conduit fitting 58. The suppressant conduit 44 is installed to a second sleeve portion 64 of the conduit sleeve 60, and secured thereto by, for example, a plurality of barbs 66 extending radially inwardly from the second sleeve portion 64 that engage an outer conduit surface 68 of the suppressant conduit 44. This connection of the suppressant conduit 44 to the second sleeve portion 64 is, however, merely exemplary and one skilled in the art will readily appreciate that the suppressant conduit 44 may be secured to the conduit sleeve 60 by other means, such as clamps or the like. Further, while in the embodiment of FIG. 3 the suppressant conduit 44 is installed into an inner sleeve surface 70 of the second sleeve portion 64, in other embodiments the suppressant conduit 44 is installed onto an exterior of the second sleeve portion 64 at an outer sleeve surface 72.

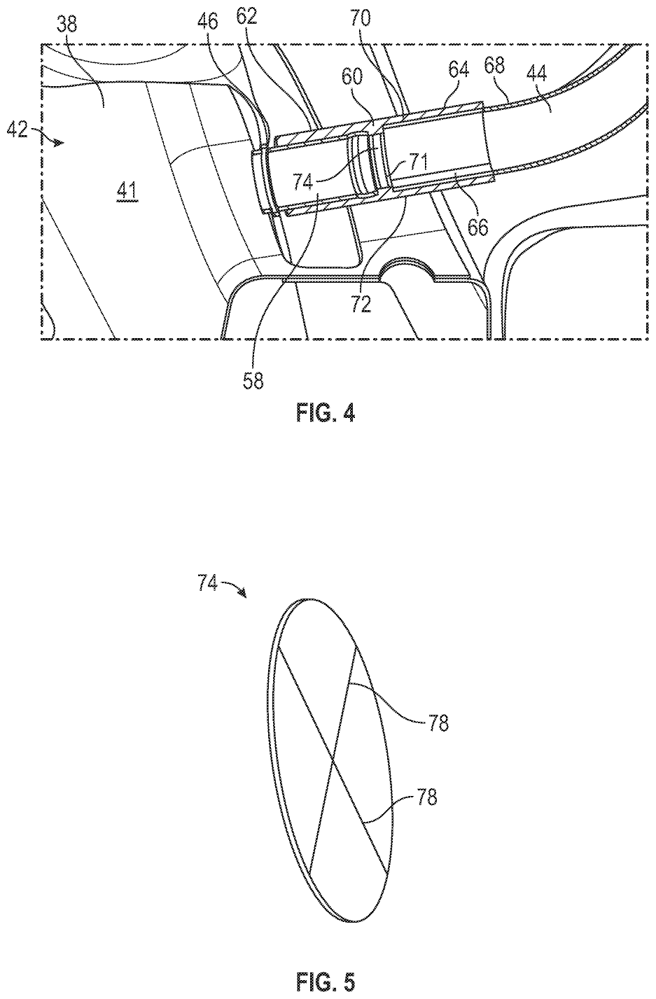

To prevent tampering with the battery assembly 38 and to seal the battery housing 42, an activation element 74 such as a disk or similar is installed into an interior of the conduit sleeve 60, for example, at an interior of the conduit fitting 58, as in FIG. 3, or alternatively at an entrance 71 of the conduit fitting 58 or other location as illustrated in FIG. 4, or inside of the second sleeve portion 64. The activation element 74 is actuated based on one or more of pressure exceeding a pressure threshold or temperature exceeding a temperature threshold. The activation element 74 may be formed from, for example, a metallic or nonmetallic material, and is in some embodiments, formed from an aluminum material. The activation element 74 may be secured to the interior of the conduit fitting 58 or the conduit sleeve 60 by, for example, brazing, welding, crimping, sealing or the like, and provides a pressure barrier to seal an interior 41 of the battery housing 42. The activation element 74 may be sized such that the thermal inertia of the activation element 74 does not degrade to cause rupture in a designed thermal event, but under extreme failure modes where the first responder access is needed it would open.

In some embodiments, the activation element 74 includes one or more features to enable the activation element 74 to rupture when a pressure in a preselected range of pressures is applied to the activation element 74. In some embodiments, the activation element 74 is formed from an aluminum material, while in other embodiments the activation element 74 may be formed from other metallic or plastic materials configured to provide the required rupture characteristics, while also withstanding the temperatures and pressures associated with a designed thermal runaway event. Further, as an alternative to brazing or welding the rupture disk 74 into position in the conduit fitting 58 or the conduit sleeve 60, a sealant or a rubber seal may be utilized to secure the activation element 74 in place.

Referring now to FIG. 5, as stated above the activation element disk 74 includes one or more features that enable the activation element 74 to rupture at the preselected pressure. In the illustrated embodiment, the activation element 74 includes one or more grooves 78 or other areas of localized reduced thickness in the activation element 74 to enable the activation at the preselected pressure. In other embodiments, the activation element 74 as a whole has a material thickness such that the activation element 74 will, for example, rupture, fold, collapse or the like at the preselected pressure. The preselected pressure is greater than a pressure of a design thermal runaway event, and also greater than a standard pressure test to which the battery assembly 38 is subjected during assembly and test of the battery assembly 38. The preselected pressure is selected to be the pressure of water from a standard fire hose that utilizes the suppressant conduit 44 accessed by the flood port 50 to direct a flow of suppressant such as water into the battery assembly 38.

A typical thermal runaway event could show a pressure of about 6.52 psi gauge (21.03 absolute) or higher during the event, or alternatively a gauge pressure increase of 2 psi or greater during a thermal runaway event. The activation element 74 is configured to activate at a pressure much greater than such an event pressure. The fire hose would supply water at a preselected pressure significantly higher than the pressure during the thermal runaway event. In some embodiments, the preselected pressure is in the range of about 50-200 psi, and the preselected pressure is, in some embodiments 100 psi or greater, thus allowing the flow of water to be directed into the battery assembly 38. Additionally, the pressure disk 74 may be configured to rupture or melt in an extraordinary thermal event where temperatures exceed those of a design thermal runaway, which is in the range of about 500-1200 degrees Celsius. This temperature rupture threshold is, in some embodiments, based on one or more of absolute maximum temperature experienced by the pressure disk 74, or may alternatively be based on a dynamic temperature over time.

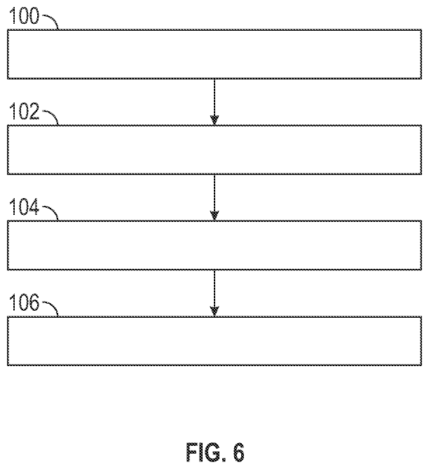

Referring now to FIG. 6, a method of assembly of a battery assembly 38 is illustrated. At step 100, the pressure disk 74 is secured into the conduit fitting 58 by, for example, welding or brazing. In one embodiment, the securing of the pressure disk 74 is achieved via oven brazing. At step 102, the conduit fitting 58 is installed to the battery housing 42 and secured to the battery housing 42, specifically at the conduit port 46 by, for example, a welding or brazing process. In some embodiments a sealant is installed to the joint between the conduit fitting 58 and the conduit port 46. The assembly is now a sealed pressure vessel, and may be pressure tested and/or leak tested at step 104. At step 106, the suppressant conduit 44 is installed to and secured to the conduit fitting 58 via, for example, the conduit sleeve 60.

Utilization of the pressure disk 74 in the conduit fitting 58 prevents tampering with the battery assembly 38 via the suppressant conduit 44, yet allows for activation or rupturing when, for example a first responder utilizes a fire hose to direct a flow of water through the suppressant conduit 44 toward the battery assembly 38. The pressure disk 74 ruptures at a pressure only greatly exceeding that of a design thermal runaway event, and/or at a temperature greatly exceeding that of a design thermal runaway event. Further, installation and sealing of the pressure disk 74 into the conduit fitting 68 allows for improvements in ease of leak testing of the battery assembly 38.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery assembly of a vehicle, comprising:
a one or more battery cells;
a battery housing in which the one or more battery cells are disposed;
a suppressant conduit extending from the battery housing and configured to deliver a flow of fire suppressant to the one or more battery cells; and
an activation element configured to block the suppressant conduit and activate when a pressure exceeding a preselected threshold pressure is applied to the activation element, allowing a flow of fire suppressant to flow into the battery housing.

2. The battery assembly of claim 1, further comprising a conduit fitting secured to the battery housing and to which the suppressant conduit is operably connected;
wherein the activation element is disposed inside the conduit fitting.

3. The battery assembly of claim 2, wherein the activation element is secured in the conduit fitting by one of welding, brazing, crimping or sealing.

4. The battery assembly of claim 1, wherein the activation element is configured to activate at a pressure of 50 psi or greater.

5. The battery assembly of claim 1, wherein the pressure disk is configured to activate at a temperature greater that 1200 degrees Celsius.

6. The battery assembly of claim 1, wherein the activation element includes one or more localized reductions in thickness to enable the activation at the preselected threshold pressure.

7. The battery assembly of claim 1, wherein the activation element is formed from a metallic material.

8. The battery assembly of claim 1, wherein the suppressant conduit extends from the battery housing to a flood port disposed at an exterior of the vehicle.

9. A vehicle, comprising:
a vehicle body defining a passenger compartment; and
a battery assembly disposed at the vehicle body, the battery assembly including:
a one or more battery cells;
a battery housing in which the one or more battery cells are disposed;
a suppressant conduit extending from the battery housing and configured to deliver a flow of fire suppressant to the one or more battery cells; and
an activation element configured to block the suppressant conduit and activate when a pressure exceeding a preselected threshold pressure is applied to the activation element, allowing the flow of fire suppressant into the battery housing.

10. The vehicle of claim 9, further comprising a conduit fitting secured to the battery housing and to which the suppressant conduit is operably connected;
wherein the activation element is disposed inside the conduit fitting.

11. The vehicle of claim 10, wherein the activation element is secured in the conduit fitting by one of welding, brazing, crimping or sealing.

12. The vehicle of claim 9, wherein the activation element is configured to activate at a pressure of 50 psi or greater.

13. The vehicle of claim 9, wherein the activation element is configured to activate at a temperature greater that 1200 degrees Celsius.

14. The vehicle of claim 9, wherein the activation element includes one or more localized reductions in thickness to enable the activation at the preselected threshold pressure.

15. The vehicle of claim 9, wherein the activation element is formed from a metallic material.

16. The vehicle of claim 9, wherein the suppressant conduit extends from the battery housing to a flood port disposed at an exterior of the vehicle body.

17. A method, comprising:
positioning an activation element between a suppressant conduit and a battery assembly of a vehicle;
directing a flow of suppressant along the suppressant conduit toward the battery assembly;
activating the activation element via the suppressant pressure on the activation element; and
flowing the suppressant into the battery assembly.

18. The method of claim 17, wherein the activation element is configured to activate at a pressure of 50 psi or greater.

19. The method of claim 17, wherein a conduit fitting is secured to the battery assembly and the suppressant conduit is operably connected thereto;
wherein the activation element is disposed inside the conduit fitting; and
wherein the activation element is secured in the conduit fitting by one of welding, brazing, crimping or sealing.

20. The method of claim 17, further comprising directing the flow of suppressant along the suppressant conduit via a flood opening at an exterior of the vehicle.
